(19) United States
(12) Patent Application Publication
(10) Pub. No.: US 2011/0113319 A1
(43) Pub. Date: May 12, 2011

(54) INTRODUCING A FORM INSTANCE INTO AN INFORMATION CONTAINER

(75) Inventors: Yitzhak Saft, Tel Aviv (IL); Simon Chulsky, Netanya (IL); Liron Hayun, Tel Aviv (IL)

(73) Assignee: KCS - KNOWLEDGE CONTROL SYSTEMS LTD., Ness Ziona (IL)

(21) Appl. No.: 12/673,717

(22) PCT Filed: Aug. 13, 2008
(86) PCT No.: PCT/IL08/01116

§ 371 Date: Feb. 16, 2010

Related U.S. Application Data
(60) Provisional application No. 60/955,562, filed on Aug. 13, 2007.

(51) Int. Cl. G06F 17/00

(52) U.S. Cl. 715/223

(57) ABSTRACT

Some embodiments of the invention relate to a system and a method of enabling introduction of a form instance into an information container. According to some embodiments of the invention, a system for enabling introduction of a form instance into an information container may include a form provisioning module and a host application interaction module. The form provisioning module may be configured for providing a form template from amongst a plurality of form templates, each one of the form templates may include one or more data fields and at least one of the data fields may include metadata and an editable value. The host application interaction module may be configured to interact with an information manipulation environment that is associated with the information container, to thereby invoke within the information container a form instance that is based upon one of the plurality of form templates, and to thereby enable editing of at least one value of one field of the form instance. The host application interaction module may be further adapted to store within an embedded storage layer of the information container data corresponding to one or more fields of the form instance, in a manner to enable access to the fields autonomously through the information container. According to some embodiments of the invention, the system may include a form data publisher. The form data publisher may be adapted to publish data corresponding to one or more fields of the form instance for provisioning storage thereof on a remote storage component. According to further embodiments of the invention, the data associated with the form instance within each of the embedded storage areas and the remote storage components may exist autonomously of one another.

### FIELD OF THE INVENTION

This invention relates to the field of knowledge management. More particularly, the present invention relates to a system and a method for enhancing functionality of unstructured software environments.

### BACKGROUND OF THE INVENTION

US Patent Application Publication No. 2002/0065849, published on May 30, 2002, discloses a system and method for providing network-based functionality to a word processing document which include, on the client side, a productivity application which is augmented with network-enabling software that provides users with new network-based functionality, which may be accessed within the productivity application. The network-enabling software enables users to generate and modify word processing documents by embedding network-enabling objects that can launch and make use of network-based functionality from within the productivity application. The invention further includes remote server support for the network-enabling software that augments the personal computer application, and as well as providing support for the resulting word processing document. Network-based content may be placed, for example, in a table, at a specific insertion point or within an embedded portion of another document type within a word processing document. The network-based content may be static or may be dynamically updated based upon a change in the network-based content at the network source. The end user may selectively decide to refresh network based content objects at their discretion and at any time during the use of the word processing document.

US Patent Application Publication No. 2002/0129054, published on Sep. 12, 2002, discloses a system and method for providing network-based functionality to a spreadsheet which includes, on the client side, a personal computer application which is augmented with network-enabling software that provides users with new network-based functionality that can be accessed within the personal computer application. The network-enabling software enables users to generate and modify spreadsheets by embedding network-enabling objects that can launch and make use of network-based functionality from within the personal computer application. Also included is remote server support for the network-enabling software that augments the personal computer application, and as well as support for the resulting spreadsheet.

US Patent Application Publication No. 2003/0158865, published on Aug. 21, 2003, discloses systems, methods, and apparatus, including computer program products, for accessing data objects stored in multiple repositories. A repository framework includes a plurality of repository managers. Each repository manager is configured to provide access to an associated repository. The repository framework includes a uniform interface for accessing the data objects, and provides a unified name space with a unique reference for each data object. Each repository manager may include a plurality of sub-managers adapted to map operations in the uniform interface to repository-specific operations. A repository manager may enhance the functionality of a repository by implementing an operation in the uniform interface for which there is no corresponding repository-specific operation. Some implementations enable users to access data objects without knowing the location, type, or format of the data objects. The benefits provided by a central repository may thus be realized without necessarily having to move data objects from their individual repositories.

### SUMMARY OF THE INVENTION

Some embodiments of the invention relate to a system and a method of enabling introduction of a form instance into an information container. According to some embodiments of the invention, a system for enabling introduction of a form instance into an information container may include a form provisioning module and a host application interaction module. The form provisioning module may be configured for providing a form template from amongst a plurality of form templates, each one of the form templates may include one or more data fields and at least one of the data fields may include metadata and an editable value. The host application interaction module may be configured to interact with an information manipulation environment that is associated with the information container, to thereby invoke within the information container a form instance that is based upon one of the plurality of form templates, and to thereby enable editing of at least one value of one field of the form instance. The host application interaction module may be further adapted to store within an embedded storage layer of the information container data corresponding to one or more fields of the form instance, in a manner to enable access to the fields autonomously through the information container.

According to further embodiments of the invention, the host application interaction module may be adapted to interact with the information manipulation environment, to thereby add to a presentation layer of the information container an indication with respect to the form instance and/or an indication with respect to any of its fields.

According to yet further embodiments of the invention, the host application interaction module may be adapted to generate the indication with respect to the form instance so that the indication provides a visual representation of a metadata and/or a content of a field of the form instance.

According to still further embodiments of the invention, the host application interaction module may be adapted to link the metadata and/or the content that is associated with the form instance within the embedded storage layer with the indication with respect to the form instance, such that in case the metadata and/or the content is updated, the update is reflected by the respective indication.

According to further embodiments of the invention, the system may further include a form template repository for storing form templates. According to some embodiments of the invention, the form provisioning module may be adapted to retrieve a form template from the form template repository in response and based upon a request from a user including details about a requested form template and/or based upon a predefined criterion. According to further embodiments of the invention, the form template repository may be configured to store ready-made form templates and user defined form templates.

According to still further embodiments of the invention, the system may include a form template user interface. The form template user interface is configured to enable a user to create a new form template or to modify an existing form template, and the form template user interface may further enable a user to store the new or modified form template on the form template repository.

According to some embodiments of the invention, the system may include a form data publisher. The form data publisher may be adapted to publish data corresponding to one or more fields of the form instance for provisioning storage thereof on a remote storage component. According to further embodiments of the invention, the data associated with the form instance within each of the embedded storage areas and the remote storage component may exist autonomously of one another.

According to some embodiments of the invention, the host application interaction module may be adapted to detect a change in respect of the data corresponding to one or more fields of the form instance within the embedded storage layer, and wherein the host application interaction module may be responsive to the detected change for causing the data corresponding to one or more fields of the respective form instance on the remote storage component to be updated according to the change.

According to some embodiments of the invention, the system may further include a change monitor. The change monitor may be configured to detect a change with respect to a form instance record on the remote storage component. The change monitor may be responsive to the change being detected for providing an indication about the change to a host application interaction module which is associated with an information container which includes a respective record which corresponds to the form instance in respect of which the change was detected on the remote storage component.

According to some embodiments of the invention the host application interaction module may be responsive to the indication being received for updating the respective form instance record according to the change indication. According to further embodiments of the invention, the host application may be further adapted to cause one or more of the following:
invocation of a comparison between a content of a selected form instance that is stored within an embedded storage layer of an information container and a content of a record on a remote storage component which corresponds to the selected form instance;
opening of a respective form instance that is stored within an embedded storage layer of an information container for enabling editing of said form instance;
deletion of a respective form instance from an embedded storage layer of an information container;
retrieval of data corresponding to a respective form instance from a remote storage component and storage of said retrieved data within an embedded storage layer of an information container; and
disconnection of a link between a selected form instance stored within an embedded storage layer of an information container and a respective record corresponding to the selected form instance that is stored on a remote storage component.

According to still further embodiments of the invention, the system may further include a plurality of remote storage components and a controller. According to some embodiments of the invention, one or more of the remote storage components may be configured to store data in respect of a form instance(s) of a specific type. The controller may be responsive to the form data publisher publishing data corresponding to a form instance, for determining a type of the form instance. The controller may be responsive to the type of the form instance, for directing the data corresponding to the respective form instance to a specific one of the plurality of remote storage components for being stored thereon.

According to some embodiments of the invention a method of enabling introduction of a form instance into an information container may include selecting a form template from amongst a plurality of form templates, each one of the form templates including one or more data fields and at least one of the data fields including metadata and an editable value; invoking a form instance that is based upon the selected form template within an information container that is associated with an information manipulation environment; editing at least one value of one field of the form instance; and storing within an embedded storage layer of the information container data corresponding to one or more fields of the form instance, in a manner to enable access to the fields autonomously through the information container.

According to further embodiments of the invention, the method accordingly may further include adding to a presentation layer of the information container an indication with respect to the form instance or with respect to any of its fields. According to still further embodiments of the invention, adding the indication to the presentation layer may further include generating the indication with respect to the form instance so that the indication provides a visual representation of a metadata and/or a content of a field of the form instance.

According to some embodiments of the invention, the method may further include linking the metadata and/or the content that is associated with the form instance within the embedded storage layer with the indication with respect to the form instance, such that in case the metadata and/or the content is updated, the update is reflected by the indication.

According to further embodiments of the invention, the selecting a form template may further include retrieving the selected form template from a form template repository in response and based upon a request from a user including details about a requested form template and/or based upon a predefined criterion.

According to still further embodiments of the invention, the method may further include publishing data corresponding to one or more fields of the form instance in a manner to enable storage of the one or more fields of the form instance on a remote storage component. According to yet further embodiments of the invention, the data associated with the form instance within each of the embedded storage areas and the remote storage component may exist autonomously of one another, such that the data corresponding to one or more fields of the form instance is accessible autonomously from the information container, without being required to retrieve data from any remote data source.

According to some embodiments of the invention, the method may further include detecting a change in respect of the data corresponding to one or more fields of the form instance within the embedded storage layer; and causing the respective data corresponding to one or more fields of the form instance on the remote storage component to be updated according to the change.

According to some embodiments of the invention, the method may further include detecting a change with respect to a form instance record on the remote storage component; and providing an indication about the change to a host application interaction module which is associated with an information container which includes a record which corresponds to the changed form instance in respect of which a change was detected on the remote storage component. According to further embodiments of the invention, the method may further include updating the respective form instance record according to the change indication.

According to some embodiments of the invention, the method may include providing a plurality of remote storage components, one or more of the remote storage components may be configured to store data in respect of form instance of a specific type; determining type of a form instance in respect of which data is being published; and directing the data corresponding to the form instance to a specific one of the plurality of remote storage components for being stored thereon according to the type of the form instance.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram illustration of a system for enabling introduction of form instances into an information container, according to some embodiments of the invention;

FIG. 2 is a block diagram illustration of various layers and areas of an information container and an information manipulation environment which may be involved in the process of invoking a form instance within an information container, according to some embodiments of the invention;

FIG. 3 is a flow chart illustration of a method of introducing a form instance into an information container, according to some embodiments of the invention;

FIGS. 4A to 4D collectively provide a graphical illustration of a process of introducing a form instance into a Microsoft® Office Word 2003 document, according to some embodiments of the invention;

FIG. 5 is a block diagram illustration of the components of a system for enabling introduction of a form instance into an information container, which are involved in the publishing of data corresponding to a form instance on one or more remote storage devices and which are adapted to establish a link between the corresponding data elements, in accordance with some embodiments of the invention;

FIG. 6 is a flowchart illustration of a scenario whereby a form instance is introduced into an information container according to some embodiments of the invention; and

FIG. 7 is a block diagram of various applications of a system and a method of enabling introduction of a form instance into an information container and of possible interactions between copies of a certain form instance across different information containers and different information manipulation environments, according to some embodiments of the invention.

It will be appreciated that for simplicity and clarity of illustration, elements shown in the figures have not necessarily been drawn to scale. For example, the dimensions of some of the elements may be exaggerated relative to other elements, for clarity. Further, where considered appropriate, reference numerals may be repeated among the figures to indicate corresponding or analogous elements.

### DETAILED DESCRIPTION OF EXEMPLARY EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “generating”, “assigning” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

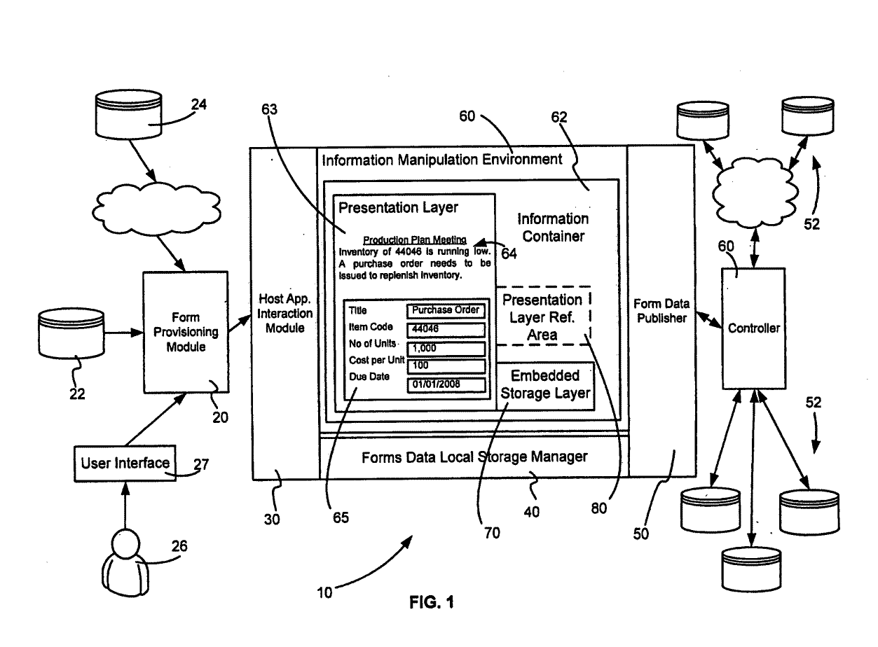

Turning now to FIG. 1, there is shown a block diagram illustration of a system for enabling introduction of form instances into an information container, according to some embodiments of the invention. According to some embodiments of the invention a system 10 for enabling introduction of form instances into an information container may include a form provisioning module 20, a host application interaction module 30 and a form instances local storage manager 40. According to further embodiments of the invention, the system 10 may further include a forms data publisher 50.

The system 10 may be associated with an information manipulation environment 60. The term “information manipulation environment” as used herein relates to any software application which allows creating and editing of information containers. The term “information container” as used herein relates to any software objects or entities that are intended to contain and manipulate computerized data. Examples of information containers may include word processor documents, emails, presentations spreadsheets, GIS maps, etc. Non-limiting examples of an information manipulation environment 60 with respect to which the system 10 may be implemented include, but are not limited to the following: Microsoft® Office Word 2003 and 2007 versions, Microsoft® Office Excel 2003 and 2007 versions, Microsoft® Office PowerPoint 2003 and 2007 versions, Microsoft® Office Outlook 2003 and 2007 versions, Corel® WordPerfect® Office™, OpenOffice Writer, OpenOffice Calc, OpenOffice Impress, Google Docs & Spreadsheets. Throughout the specification and the claims the terms “information manipulation environment” and “host application” or the like are used interchangeably and are intended to have a similar meaning.

The information manipulation environment 60 may enable to generate an information container 62 into which form instance 64 may be entered, such as the text input shown in FIG. 1, for example.

According to some embodiments of the invention, the host application interaction module 30 may be configured to interact with the information manipulation environment 60. The host application interaction module 30 may interact with an information container 62 generated by the information manipulation environment 60. The host application interaction module 30 may interact with the information manipulation environment 60 to thereby invoke a form instance within an information container 62 generated by the information manipulation environment 60.

According to some embodiments of the invention, the host application interaction module 30 may invoke the form instance within the information container 62 by adding to the information container 62 or by associating with information container 62 a data component (the form instance) which can be interpreted by the host application interaction module 30 to become one or more form instance elements. According to some embodiments of the invention, the host application interaction module 30 may be configured to embed or otherwise associate an information container 62 with a collection of one or more form instance fields or form instance elements. The form instance fields or elements may include metadata or attributes (with some value(s)) and editable data or value(s). According to some embodiments of the invention, the host application interaction module 30 may be configured to embed or otherwise associate an information container 62 with a data component which includes markup language tags that are intended for describing the data or the values within the data component.

As mentioned above, according to some embodiments of the invention, a markup language may be used to provide the structure of the form instance. For purposes of clarity, within the context of markup languages, the term “metadata” shall be used herein to refer also to an attribute of a form instance field or of an element of a markup language. Further for purposes of clarity, within the context of markup languages, the terms “data”, “content” and “value” shall be used herein to refer to a content of a field or of an element of a markup language (including empty content item or element).

In accordance with one non-limiting example, the form instance may include Extensible Markup Language (XML) tags, The XML tags may be used to define different forms and to provide structure for the forms. The XML tags may also be used to provide metadata for one or more of the data, which according to one example, may provide data about the data or value with which the tag is associated. Typically, and according to some embodiments of the invention, a value or some piece of data may be associated with an XML tag by wrapping the data or value with the associated XML tag. According to some embodiments, the host application interaction module 30 may be configured to identify that a certain data component includes XML tags (as an example of markup language tags), and may be configured to handle data which is marked by XML tags according to the general rules of XML and according to specific definitions or rules with respect to the XML tags, the metadata and the data or values that are associated with a certain XML data component (a form instance) or with a certain XML tag.

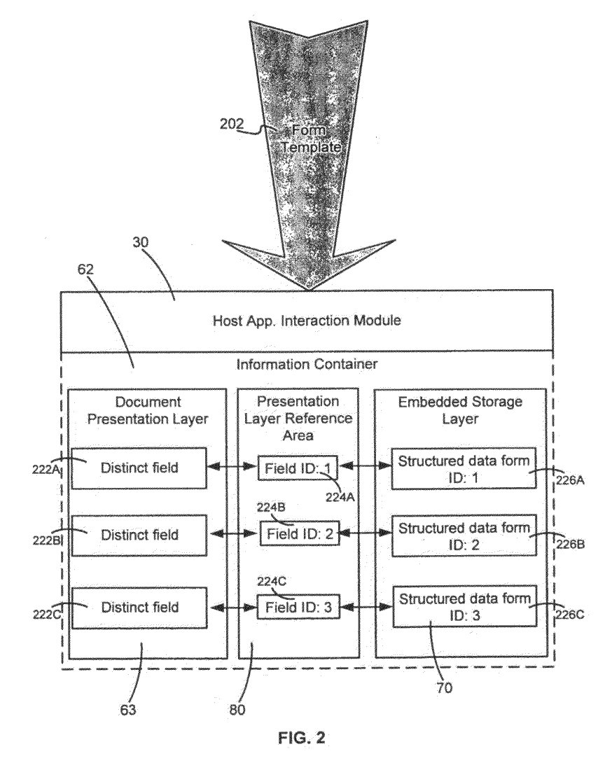

Having discussed some details of the form instance which, according to some embodiments of the invention, may be invoked within an information container, there is now provided a description of one non-limiting example of a way by which the form instance may be invoked within an information container. The example is provided with reference to FIG. 2, which is a block diagram illustration of various layers and areas of an information container and an information manipulation environment which may be involved in the process of invoking a form instance within an information container, according to some embodiments of the invention. The description of FIG. 2 begins with the receipt of a form template 202. The form template 202 may be received at the host application interaction module 30, for example, in response to a request that was issued by the host application interaction module 30.

According to some embodiments of the invention, upon receiving the form template, the host application interaction module 30 may be adapted to invoke a form instance corresponding to the received template within the information container 62. It would be appreciated that the host application interaction module 30 (or any other suitable component of the system 10) may be configured to process the form template, in case some processing of the template is required in order to convert the template and generate the form instance.

Moving forward with the description of FIG. 2, according to some embodiments of the invention, as part of invoking a form instance within an information container, the host application interaction module may create a distinct area or field 222A-222C within a presentation layer 63 of the information container 62. According to some embodiments of the invention, a distinct area or field may be any area within the presentation layer of the information container 62 which can be referenced and whose reference can be determined or at least can be made available to the host application interaction module 30. For example, in Microsoft® Office Word 2003 there is support for defining a certain area within the presentation layer as a field. An area which is defined as a field in Microsoft® Office Word 2003 may receive some reference or an ID and may be addressed and/or manipulated according to its reference. Another example is Microsoft® Office PowerPoint 2003 where there is support for inserting an image object to the presentation layer. An image object in Microsoft® Office PowerPoint 2003 may receive some reference or an ID and may be addressed and/or manipulated according to its reference.

There is now provided a non-limiting example according to some embodiments of the invention. The following example sets forth a possible implementation of some aspects of the invention which are applicable to Microsoft® Office Word 2003 (as an example) information manipulation environment. The following example is intended to provide one example of how the referencing of a distinct area within an information container and of providing the reference to enable addressing and manipulation of the reference area according to the reference that may be achieved.

According to one example, a certain area within the presentation layer 63 of a Microsoft® Office Word 2003 document may be defined as being a distinct field 222A-222C. According to some embodiments of the invention, a distinct field 222A-222C that is defined in connection with the process of invoking a form instance within an information container 62 may be associated with a form instance, and may provide some graphical presentation of the respective form instance within the presentation layer 63 of the information container 62. According to further embodiments of the invention, the distinct field 222A-222C within the presentation layer 63 may provide a graphical presentation of one or more of the following: a field or fields of the form instance (e.g., the element of the form in case it is an XML document), a metadata of the form instance (e.g., a value of a variable within an XML document) and data or content or a value of the form instance. A further discussion of the graphical presentation of a form instance within the presentation layer of an information container within which the form is invoked shall be provided below.

The distinct field 222A-222C may be associated with a distinct ID and may be referenced according to the respective distinct ID. According to some embodiments of the invention, the host application interaction module 30 may be adapted to associate each field within the presentation layer 63 with a substantially unique ID (for example, a GUID). According to further embodiments of the invention, the substantially unique ID may be added to the metadata of the field 222A-222C.

As is shown in FIG. 2, and according to some embodiments of the invention, a plurality of distinct fields 222A-222C may be defined within a information container 62. According to some embodiments, the distinct ID of each field that is associated with a form instance may be stored within a presentation layer reference area 230 of Microsoft® Office Word 2003. As is shown in FIG. 2 each one of the distinct fields 222A-222C defined within the presentation layer 63 of the information container 62 is distinctly associated with a respective reference item 224A-224C within the presentation layer reference area 230.

According to some embodiments of the invention, in Microsoft® Office Word 2003 the bookmarks utility may be used to provide the presentation layer reference area 230, and the distinct ID of the various fields 222A-222C may be stored within the bookmarks area in respective reference items 224A-224C. Thus, selecting a certain distinct ID that is registered in the bookmarks area may enable to address the distinct area or the field within the presentation layer of the documents that is associated with that distinct ID and vice-versa, selecting a distinct area or the field within the presentation layer of the document may provide reference to the distinct ID registry in the bookmarks area that is associated with the selected field.

It should be appreciated that according to some embodiments of the invention, the use of the presentation layer reference area as part of the process of invoking a form instance within an information container is optional. Furthermore, it should be appreciated that with some information manipulation environments it may not be necessary or it may not be possible or applicable to save a reference to a distinct area of the presentation layer within some well-defined presentation layer reference area that is supported by the information manipulation environment.

According to some embodiments of the invention, the host application interaction module 30 may be otherwise configured to define a certain area within an information container 62 as being distinct and to provide a distinct reference to that distinct area within the presentation layer of the information container 62.

Having described the referencing of an area or a field within a presentation layer of an information container, the description of the process of invoking a form instance within an information container is now resumed. As mentioned above, according to some embodiments of the invention, the process of invoking a form instance within an information container may include storing within an embedded storage layer 70 of an information container 60 data corresponding to one or more fields 222A-222C of the form instance. In FIG. 2, and according to some embodiments of the invention, a distinct record 226A-226C is created within the embedded storage layer 70 for each respective field 222A-222C within the presentation layer 63.

According to further embodiments of the invention, as mentioned above each record 226A-226C within the embedded storage layer 70 of the information container may be distinctly associated with a respective presentation layer field 222A-222C. According to further embodiments of the invention, each record 226A-226C within the embedded storage layer 70 of the information container may include a reference to the presentation layer field 222A-222C that is associated with the same form instance. Thus, according to yet further embodiments of the invention, a two way link may be established between a presentation layer field 222A-222C and a corresponding record 226A-226C within the embedded storage portion 70 of the information container. According to still further embodiments of the invention, the presentation layer field 222A-222C may enable to provide a graphical presentation of certain aspects of the form instance, whereas the data 226A-226C within the embedded storage portion 70 may provide the actual data within the form and the structure of the form.

Thus, it would be appreciated that according to some embodiments of the invention, invoking a form instance within an information container may include at least defining a field or some reference area within the presentation layer of the information container and creating a corresponding record within an embedded storage layer of the information container, the record including the data associated with the form and data corresponding to the structure of the form.

Referring back to the example of Microsoft® Office Word 2003, as part of a process of invoking a form instance within a Microsoft® Office Word 2003 document, data corresponding to one or more fields (e.g., elements in case of XML) of the form instance may be stored within a variables storage layer of the document. For example, if the form instance is represented by an XML document, the XML document in its entirety may be saved within the variables layer as a string of plain text, with the addition of the unique ID of the presentation layer field with which this particular XML document is associated.

Continuing with the description of the interaction between the host application interaction module 30 the information manipulation host application 60, according to one non-limiting example, the host application interaction module 30 may be implemented as an add-in application of the information manipulation host application 60. The host application interaction module 30 may use services provided by the information manipulation host application 60, including services which provide a way for add-in applications to register themselves with the host application and a protocol by which data may be exchanged with the host application 60. According to one example, the Microsoft® office object model and certain Microsoft® office application program interfaces (APIs) may be used to enable the functional and/or graphical interfacing of the host application interaction module 30 with Microsoft® Office applications.

According to further embodiments of the invention, a graphic user interface (GUI) component of the host application interaction module 30 may be integrated with the GUI component of the information manipulation environment host application 60. For example, a toolbar that is associated with the host application interaction module 30 may be displayed as part of the GUI display of the information manipulation host application 60. The interaction between the host application interaction module 30 and the information manipulation environment 60 and particularly the GUI will be described in greater detail below.

It would be appreciated that according to further embodiments of the invention, the host application interaction module 30 may be activated outside the information manipulation host application 60 and the interaction between the host application interaction module 30 and the information manipulation host application 60 may be carried out through various services which are enabled by the information manipulation host application 60 and which permit the interaction between the host application interaction module 30 and the information manipulation host application 60, substantially as described in greater detail below. For example, the user interface of the host application interaction module 30 may be integrated or otherwise combined with the user interface of the information manipulation host application 60 and an appropriate application program interface (API) supported by the information manipulation host application 60 may be used to activate the host application interaction module 30 substantially as if it was activated from within the information manipulation host application 60.

As mentioned above, the host application interaction module 30 may be adapted to interact with the information manipulation environment 60 to thereby invoke a form instance within an information container 62. According to some embodiments of the invention, the form instance may be generated in accordance with a previously defined form template. According to further embodiments of the invention, a form instance may be an instance of a previously defined form template.

According to some embodiments of the invention the form provisioning module 20 may be configured for providing any one of a plurality of form templates. Each one of the form templates may specify one or more fields (e.g., XML elements), and with respect to some or all of the fields specified by a certain form template, metadata (e.g., XML variables) and one or more data or value fields (e.g., text content) may be specified. According to certain embodiments of the invention, at least one value or one data segment of one field in each one of the form templates may be editable. An editable value or data segment as used herein relates to a value or data segment of a form instance which may be edited or changed, for example but not limited to, by a user.

According to some embodiments of the invention, the form provisioning module 20 may be operatively connected to one or more data sources 21 from which data with respect to a form template(s) may be obtained. According to some embodiments of the invention, the form provisioning module 20 may be operatively connected to one or more databases. Each database may include one or more records, and each record may be associated with a specific form template. Each record of a form template may include a field for each element in the XML (as an example of a markup language) document represented by the form template. Each form template record in the database may include a field with a unique ID that is associated with the form template. It would be appreciated that, in accordance with some embodiments of the invention, the data within the databases may be stored as plain text. For example, plain text is inherently supported by XML standards.

In FIG. 1, different data stores which may provide form templates (the form provisioning module 20) are shown by way of example. As is shown in FIG. 1 and according to some embodiments of the invention, the form provisioning module 20 may be connected to any one or more of: a local disk 22, a remote data base 24 through a network and a user 26 (as a source of a user generated form template) through a user interface 27. The form provisioning module 20 may be configured to obtain from the data sources the necessary data with respect to a form template, so as to enable the generating of a form instance that is based upon the form template.

In accordance with some embodiments of the invention, the form provisioning module 20 may be configured to determine on which of the data stores (e.g., 22, 24 and 26) a requested template is stored and may retrieve data corresponding to the template from the relevant data store.

For example, according to some embodiments of the invention, the form provisioning module 20 may be configured to generate a query based upon, for example, data received from host application interaction module 30. The query may correspond to a requested form instance. For example, the query may be generated based upon a request made by a user of the information manipulation environment 60 to incorporate into an information container 62 a certain form instance. As will be described in further detail below, according to some embodiments of the invention, the query from the form provisioning module 20 may specify (explicitly or implicitly) to the recipient of the query which form template is requested by the form provisioning module 20 (in order to respond to the request from the host application interaction module 30). According to some embodiments of the invention, there may be various ways by which a requested form template may be specified, including, for example, specifying some or all of the fields which should be included as part of the template, specifying a unique ID that is uniquely associated with the template, specifying certain attributes or metadata and/or certain data or values that are specified by the template, etc.

In accordance with a further embodiment of the invention, the form provisioning module 20 may hold a list of currently available form templates and with respect to each template in the list, its location (where it is stored). Upon receiving a request for a certain template, the form provisioning module 20 may look it up on the list and may retrieve the respective template from the relevant data store according to the data in the form provisioning module 20. According to a further embodiment of the invention, in case the form provisioning module 20 cannot find a certain requested template on the list (for example, when the list is not updated with respect to the requested template), the form provisioning module 20 may generate a query in an attempt to locate the template, and may retrieve the template in case it is found via a response to the query.

Once the requested template is located, a form instance (e.g., an XML document) may be generated based upon the template. According to one embodiment of the invention, generating a form instance may include creating an instance of the template. However, according to further embodiments of the invention, generating a form instance may involve certain data processing and/or data manipulation processes which may be required in order to convert the form template into a valid and usable form template (e.g., creator name, creation date, form unique ID etc.).

The form provisioning module 20 may be adapted to interact with the host application interaction module 30 for providing the host application interaction module 30 with any data which may be necessary for enabling the host application interaction module 30 to invoke, within the information container 62, the form instance. For example, the form provisioning module 20 may be configured to provide the host application interaction module 30 with data regarding the fields of the form template and regarding the metadata and values associated with each field.

As mentioned above, according to some embodiments of the invention, the system for enabling introduction of a form instance into an information container 10 may include a form data publisher 50. The form data publisher 50 may be operatively connected either directly or through a network to one or more storage components 52 and may be adapted to publish data corresponding to a form instance that has been invoked within or incorporated into a information container 62. As part of publishing a form data, the form data publisher 50 may cause data corresponding to the form instance to be stored on one or more of the remote storage components 52. The form data publisher 50 may be configured to determine on which one or more of the storage components 52 the data corresponding to a certain form instance should be stored. The form data publisher 50, either independently or in cooperation with one or more of the other components of the system 10, may be configured to create a link between the data corresponding to a certain form instance within an information container 62 and the corresponding data on a remote storage entity. Further details about the operation of the form data publisher 50, and specifically, about the publishing of the data corresponding to a form instance and the linking between the two corresponding data records shall be provided below.

According to some embodiments of the invention, a form instance published to the storage component may have a version number which may be updated in response to updating of the respective form instance data on the remote storage component. The different versions of the form instance may be saved on the storage component in a way that allows viewing the form instance data changes since its creation. According to further embodiments of the invention, the form instance saved versions may also allow updating the current version of the form instance with data from previous versions, or changing the whole content of the form instance to the content of a specific previous version.

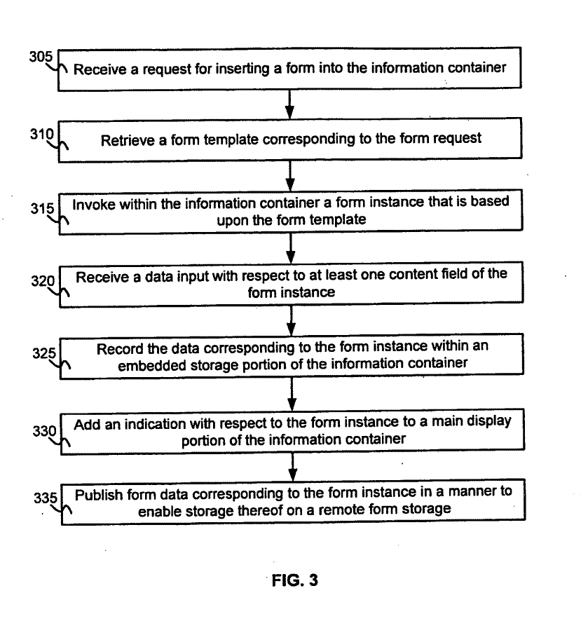

Having described the basic components of the system for enabling introduction of a form instance into an information container 62, reference is now additionally made to FIG. 3, which is a flow chart illustration of a method of introducing a form instance into an information container 62, according to some embodiments of the invention. According to some embodiments of the invention, initially, a request may be received for inserting a form instance into an information container (block 305).

According to some embodiments of the invention, the request for inserting the form instance may be generated by the host application interaction module 30. According to certain embodiments of the invention, the host application interaction module 30 may generate the request in response to an instruction received from a user. The user's instruction may be provided, for example, through the user's interaction with a GUI component that is associated with the host application interaction module 30. As mentioned above, a toolbar that is associated with the host application interaction module 30 may be integrated into or otherwise combined with the GUI of the information manipulation environment 60 or with the GUI of the information container 62. According to another example, the user may generate the request by pressing a specific combination of keyboard keys.

According to some embodiments of the invention, a request for inserting a form instance may include data about a specific form or a specific type of form which is requested for being inserted into the information container 62. As mentioned above, the system 10 may support the implementation of a variety of form templates, wherein different templates may include a different combination of fields and/or a different combination of metadata and/or a different combination data of values. For example, with reference to the embodiments of the invention illustrated by FIG. 1, the data stores 22, 24 and 26 may provide a plurality of different form templates to choose from, and the request for inserting a form instance may include data which may be used to determine which one of the plurality of available templates is being requested. For example, if a certain type of task form is of interest, the template request may include some reference to the requested template. The reference may include, for example, one or more of the following: a unique ID, one or more fields, certain metadata (or variables) and/or one or more values or content which may be associated with the requested template. In accordance with a further example, a request which does not include a designation with respect to the type of form that is being requested may be regarded as being a request for some default type form.

According to some embodiments of the invention, subsequent to the request for inserting or invoking the form instance, a form template corresponding to the requested form may be retrieved (block 310). According to some embodiments of the invention, in response to receiving a request for inserting a form instance into an information container, the host application interaction module 30 may forward the request to the form provisioning module 20. Upon receiving the request, the form provisioning module 20 may determine which template is responsive to the request and may take the necessary steps to retrieve the appropriate data which corresponds to the selected form template from the data store on which the template is stored. According to some embodiments, if more than one template is returned in response to the query, some selection logic or rules may be implemented in order to determine which template(s) best matches the request. As an alternative, more than one query result may be presented to a user and the user may be able to select which one (or more) of the templates to invoke within the information container.

Based on the retrieved form template, a form instance may be generated and/or invoked within the information container 62 (block 315). The process of invoking a form instance within an information container was previously discussed. According to some embodiments of the invention, as part of invoking a form instance an input may be received in respect of at least a content of a field of the form instance (block 320).

As mentioned above, invoking the form instance within the information container 62 may include recording data with respect to the data fields of the form instance within an embedded storage layer 80 of the information container 62 (block 325). As was also mentioned above, the invoking of the form instance within the information container 62 may also include adding to a presentation layer 63 of the information container 62 an indication 65 with respect to the form instance or with respect to any of the fields or field components of the form instance (block 330).

It would be appreciated, that in accordance with further embodiments of the invention, initially the data associated with the form template may be saved within a buffer or a cache or some other temporary storage resource, until further processing of the form instance is complete, for example, until a user is finished filling-in the form and has requested to save the data, and only at a later stage, for example, when an instruction is received to save the form instance, will it be saved in the embedded storage layer of the information container. Similarly, the indication associated with the form instance may be added to the presentation layer of the information container when an instruction to save the form instance is received and not before such an instruction is received. For example, the form data may be presented within a “pop-up” window (where the user may edit the values which are associated with each field, for example) and once an instruction is received to save the form instance, the respective indication may be added to the presentation layer of the information container.

According to some embodiments of the invention, at a certain point after the data corresponding to the form instance has been saved within the embedded storage layer of the information container, the form instance may be published in a manner to enable storage of data corresponding to the form instance on a remote storage entity (block 335). The publishing of data corresponding to a form instance(s) shall be described in greater detail below.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention, including: selecting a from template from amongst a plurality of form templates, each one of the form templates including one or more data fields and at least one of the data fields including metadata and an editable value; invoking a form instance that is based upon the selected form template within an information container that is associated with an information manipulation environment; editing at least one value of one field of the form instance; and storing within an embedded storage layer of the information container data corresponding to one or more fields of the form instance, in a manner to enable access to the fields autonomously through the information container.

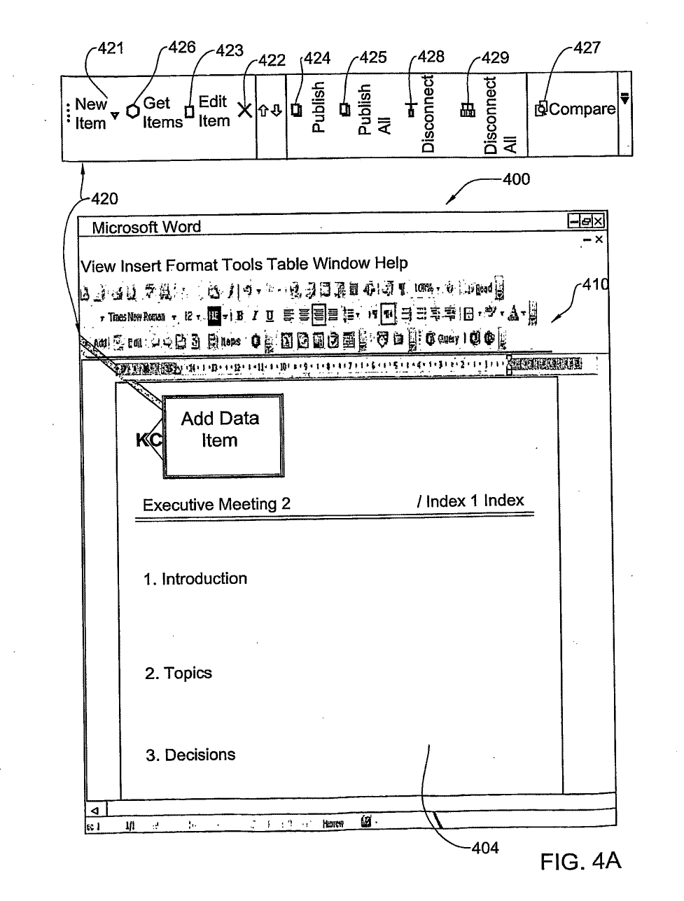

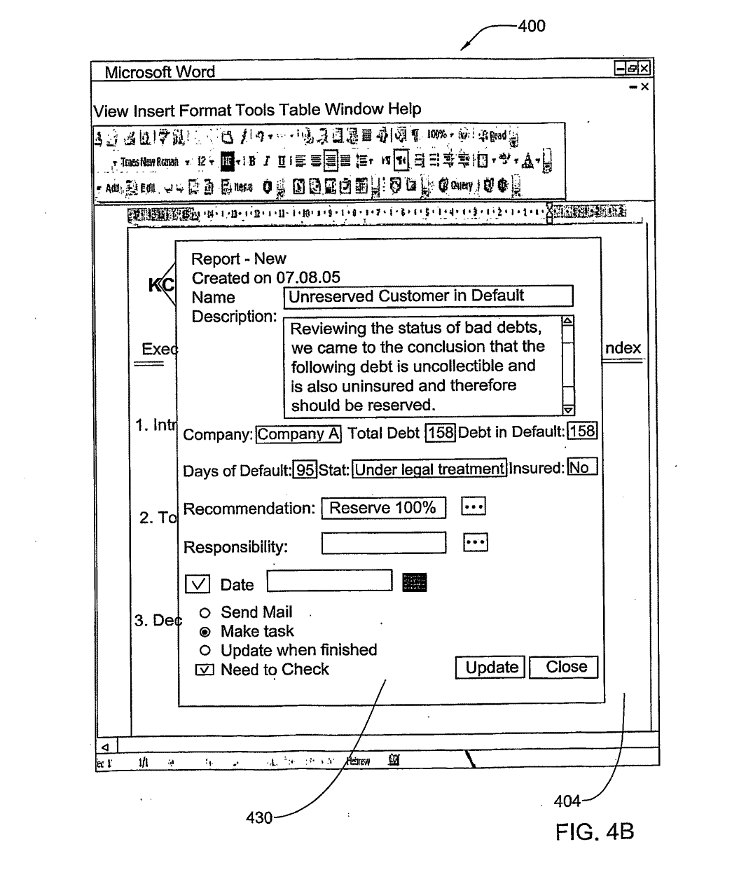

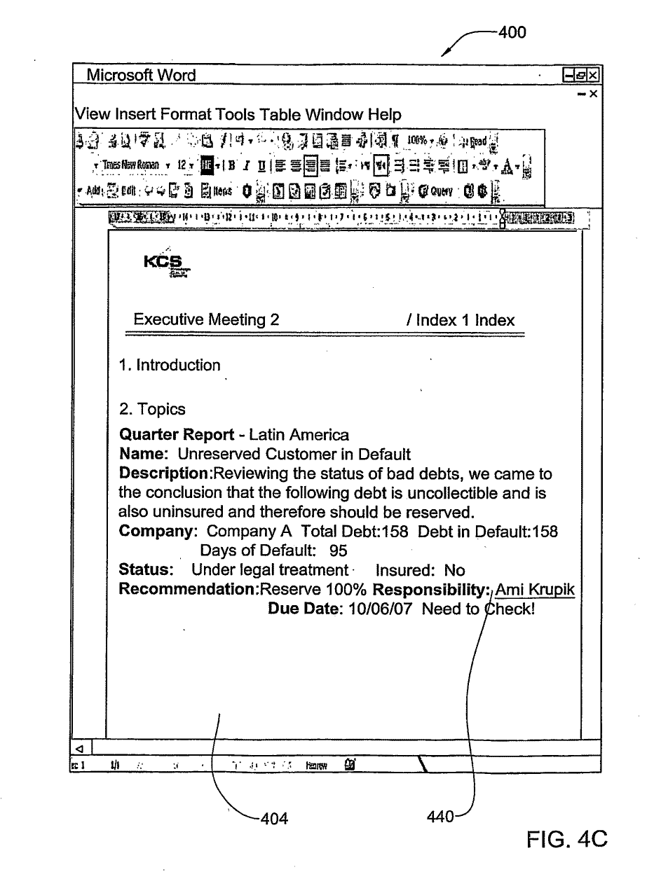

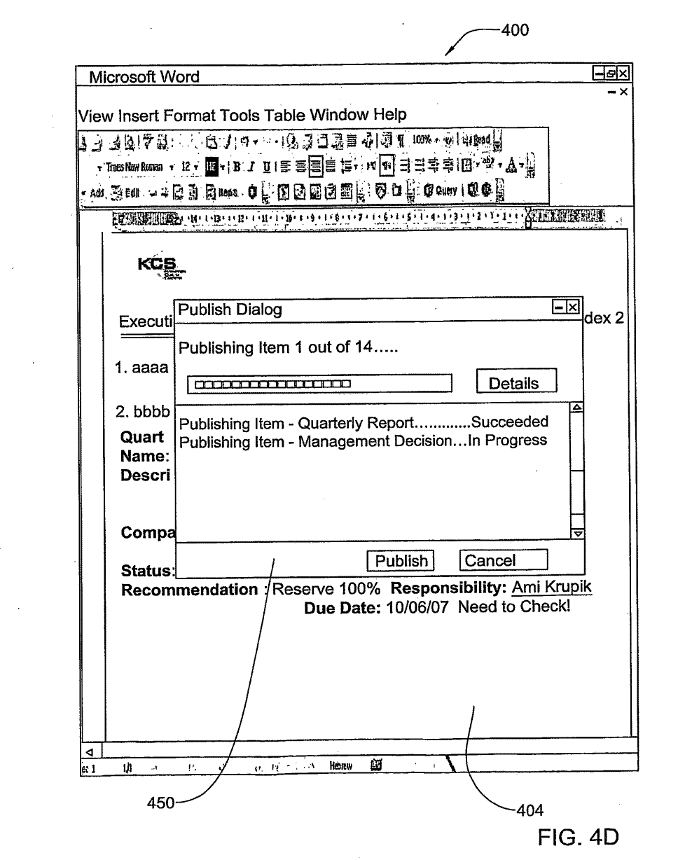

Reference is now made to FIGS. 4A to 4D which collectively provide a graphical illustration of a process of introducing a form instance into a Microsoft® Office Word 2003 document, according to some embodiments of the invention. Each one of FIGS. 4A to 4D is intended to illustrate some part of the process according to some embodiments of the invention. However, it should be appreciated that some embodiments of the invention may be comprised of only some of the details shown in FIGS. 4A to 4D and described herein with reference thereto.

Before going into the details of the description of FIG. 4A to 4D, it should be appreciated that the embodiments of the invention illustrated by FIG. 4A to 4D and described herein with reference thereto provide only an example of a possible implementation of some embodiments of the invention. Moreover, further embodiments of the invention contemplate implementation, mutatis mutandis, of the methodology described herein with reference to Microsoft® Office Word 2003 to other information manipulation environments. What is needed in order to adapt the process described herein with respect to Microsoft® Office Word 2003 is within the knowledge of those of ordinary skill in the art.

FIG. 4A provides a screen-shot illustration of an information container, specifically, a Microsoft® Office Word 2003 document 400 and an information manipulation environment, specifically Microsoft® Office Word 2003 whose GUI 410 includes a form instances toolbar 420, in accordance with some embodiments of the invention. As is shown in FIG. 4A, the presentation layer 404 of the document includes written information which is inherently supported by any Microsoft® Office Word 2003 document 400. As is also shown in FIG. 4A, a form instances toolbar 420 may be incorporated into the GUI 410 of the Microsoft® Office Word 2003 software environment. According to one embodiment of the invention, the Microsoft® office object model may be used to enable the interfacing with Microsoft® Office applications. However, it would also be appreciated that there are other ways available for adding, incorporating, interlaying, overlaying, etc. a toolbar or any other GUI component to/into/with/onto an information manipulation environment, including software environments other than Microsoft® Office Word 2003.

The toolbar 420 (as an example of a graphic interface) may enable a user to interact with the host application interaction module 30. The toolbar 420 may also enable a user to configure the host application interaction module 30, for example with respect to one or more of the processes mentioned below, or in accordance with another example, in order to enable modifying one or more management parameters of the host application interaction module 30 (e.g., which data sources should be queried). According to some embodiments of the invention, the toolbar 420 may, for example, include a button for one or more of the following:

Open a new form instance—this toolbar button is responsive to a user selecting it for generating a request for a form instance. The ‘open a new form’ instance button may ask the user to specify which form is being requested or may ask the user to provide some details and/or characteristics of the fowl the user is interested in. For example, in response to the user pressing the ‘open a new form’ instance button, a scroll down menu including a list of the available form templates will be presented to the user to choose from. In addition or as an alternative to the selection of existing templates, the user may be presented with a wizard or some other data input interface to enable the user to enter search criteria. The search criteria may be used to generate a query that is intended to return any or some of the form templates which respond to the criteria. According to some embodiments of the invention, once the user selects a certain form, or provides the criteria for selecting the form, the request is received by the host application interaction module. The handling of a user's request by the host application interaction module was discussed above in greater detail, and will be discussed in further detail below.

Open new item 421—this button 421 is operative for initiating a process that is intended for invoking a form instance within the information manipulation environment.

Create new form template (not shown)—this button is an optional addition to the open a new form instance button. This button may be configured to initiate a process that is intended for enabling a user to generate a new form template (one that is not already available on any of the data storages connected to the host application interaction module).

Delete item 422—this toolbar button 422 enables a user to delete or remove or disassociate a form instance from an information container (e.g., a Microsoft® Office Word 2003 document).

Edit item 423—this toolbar button 423 is configured to open a form instance that is already embedded or associated with an information container for enabling a user to edit the form instance content. The edit item button may enable a user to select which form instance to open for editing thereof (for example, in case there is more than one). Opening a form instance for editing is similar to the initial editing of values of a certain field of a form instance during the invocation of the form within the information container.

Publish form data 424—the publish button 424 is configured to publish a selected form instance (including data inputs with respect to the form instance) to a server or servers. Publishing of form instances shall be discussed in greater detail below.

Publish All 425—this button 425 is configured to cause the publishing of all the form instances that are embedded or associated with a certain information container.

Get Items 426—this button 426 is configured to retrieve from a remote storage device (e.g., a server) data corresponding to form instances. The button may be configured to cause the retrieval of data with respect to only some predefined or user selected form instances or, the button may be configured to cause the retrieval of any data available on the storage device(s) or servers with respect to any form instance. More details about this operation shall be provided below.

Compare 427—this button 427 is configured to invoke a comparison between a content (e.g., a value or values associated with one or more fields) of a selected form instance that is embedded within or otherwise associated with an information manipulation environment with its counterpart data on a server and vice-versa. In case as a result of the comparison it is determined that there is some difference between the two pieces of data, according to one example, a “compare window” with both copies' content may be presented to the user for enabling the user to select which version of the data to keep. In accordance with another example, predefined conflict resolution logic may be implemented to thereby automatically determine which version of the data to keep. Once a selection is made (either automatically or by a user) an update process may take place to synchronize the form instance data within or associated with the information container and the corresponding data on the server. The link between the form instance within or associated with the information container and the corresponding data on the server is described in greater detail below.

Disconnect 428—the disconnect button 428 is configured to cut-off the connection or link between a selected form instance embedded within or otherwise associated with an information container and its counterpart data on a server or on some other data storage unit. According to some embodiments of the invention, once a form instance is disconnected it may be treated as a new form instance within the information container. The disconnected form instance may be published again to a server or servers (the publish functionality was discussed above in greater detail).

Disconnect all 429—this button 429 cuts-off the connection between all form instances and their counterpart data records on a server or servers.

Reference is now made to FIG. 4B, which is a screen-shot illustration of the information container 400 and the information manipulation environment of FIG. 4A, whereon there is displayed a form instance window 430, according to some embodiments of the invention. According to some embodiments of the invention when the host application interaction module 30 receives data with respect to a certain form instance that is to be invoiced within an information container, the host application interaction module may generate a display of some fields or some data that is associated with the fields of the form instance.

For example, in the case where the form instance is provided by way of an XML document, the host application interaction module 30 may be configured to identify the tags or fields contained within the XML, identify the structure of the tags or elements (for example, identify parents and children), read the metadata or attributes and values associated with each tag or field and also read the content (including empty content) of each tag or field. The host application interaction module 30 may then generate a display which illustrates the data and the structure of the data as provided by the XML document.

For example, as is shown in FIG. 4B, fields are displayed in a specific way. Each field is associated with a field name display which is displayed as a non-editable text or form elements. The metadata associated with different fields may have some influence over the display of the field (e.g., the number of lines in a text field or the available values in a drop down list), and the values or content (of some) of the fields is displayed as editable (including empty content) or non-editable content, such as text, that is associated with a display of the field with which it is associated.

The host application interaction module 30 may display the data and may enable a user to edit the displayed data. According to some embodiments of the invention, the possibility of editing the data may be restricted, for example, according to metadata associated with each field of the form instance.

In FIG. 4B, the form instance window 430 provides a visual illustration of how a host application interaction module 30 may display a certain form instance during the process of invoking the form within an information container 404. This display may be generated prior to the storing of the data corresponding to the form instance within an embedded storage layer of the information container 404, and in this case the data may be stored in some temporary storage area or resource of the host application interaction module 30.

It should be appreciated however, that according to some embodiments of the invention, a display window that is similar to the display window 430 which is shown in FIG. 4B may also be invoked while the form instance is already stored within an embedded storage layer of the information container. For example, according to some embodiments of the invention, the host application interaction module 30 may be adapted to invoke a display window similar to the display window 430 shown in FIG. 4B whenever a certain form instance is opened for editing, for example. According to some embodiments of the invention, the host application interaction module 30 may be configured to obtain the current data which corresponds to the relevant form instance from the embedded storage layer of the information container and may generate the display based upon the data obtained therefrom.

Reference is now made to FIG. 4C, which is a screen-shot illustration of the information container 400 of FIG. 4A including an indication 440 which has been added to the presentation layer with respect to a form instance. As is shown in FIG. 4C according to some embodiments of the invention, an indication 440 may be added to the presentation layer of an information container 410 with respect to a form instance that is embedded or invoked within the information container 410.

According to some embodiments of the invention, the indication 440 may be associated with one or more fields of the form instance with which it is associated. According to further embodiments of the invention, the indication 440 may be associated with one or more of the following: a field or fields of the respective form instance (e.g., the element of the form in case it is an XML document), a metadata of the respective form instance (e.g., a value of a variable within an XML document) and data or content or a value of the respective form instance. The host application interaction module 30 may be configured to generate the indication 440 according to instructions received from a user and/or according to predefined rules.

According to some embodiments of the invention, by way of a non-limiting example, the indication 440 with respect to the form instance may take the form of any one of the following and any combination thereof: an image, a text paragraph, a table of text. The host application interaction module 30 may be adapted to convert the data corresponding to the form instance, as necessary, in order to provide the respective indication. For example, the host application interaction module 30 may be configured to process XML data (as an example) that is associated with a certain form instance into an image. According to some embodiments of the invention, processing of XML data may take into account the rules of the XML data, including parent and child relationship and including division into elements or tags or fields, metadata, and element content or values, so that these rules are reflected by the resulting indication 440.

According to some embodiments of the invention, the indication 440 may be an image which corresponds to one or more of the following: a field or fields of the respective form instance (e.g., the element of the form in case it is an XML document), a metadata of the respective form instance (e.g., a value of a variable within an XML document) and data or content or a value of the respective form instance.

As is shown in FIG. 4C the image 440 may correspond to the fields of the respective form instance and may be generated according to the various fields of the form, the metadata associated with the different fields and the content of values of the different fields. The image may be generated, for example, by an interpretation module (not shown) that builds the image out of the form instance fields. However, it should be appreciated that the indication 440 shown in FIG. 4C is merely one example of a possible indication and that according to further embodiments of the invention other indications may also be generated (e.g., an icon or a rich text format paragraph).

Reference is now made to FIG. 4D, which is a screen-shot illustration of the information container 400 of FIG. 4A including a publishing progress window 450 which may be displayed as an indication that a form instance(s) publishing process is in progress.

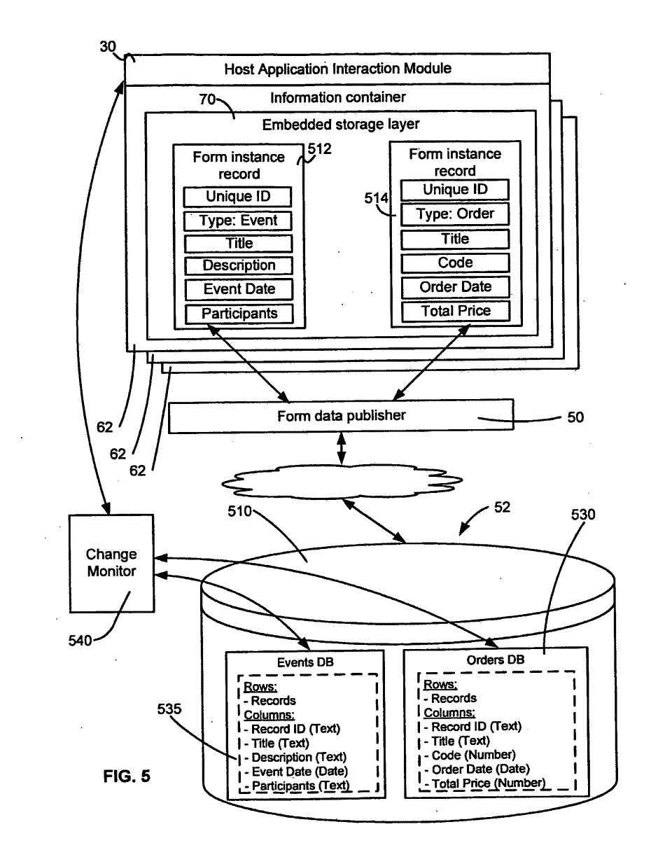

A more detailed description of the publishing process is described with reference to FIG. 5 which is a block diagram illustration of the components of the system 10 for enabling introduction of a form instance into an information container which are involved in the publishing of data corresponding to a form instance on one or more remote storage devices and which are adapted to establish a link between the corresponding data elements, in accordance with some embodiments of the invention. As can be seen in FIG. 5, an embedded storage layer 70 of an information container 62 may include one or more form instance records (for example, two as is illustrated by FIG. 5) 512 and 514. According to some embodiments of the invention, each record 512 and 514 may include one or more fields, and each field may include content or values (including an empty content). Certain records may also include data with respect to a metadata that is associated with a field of a form instance.

In FIG. 5, by way of example, the two records 512 and 514 are of different types. The first 512 record is an event type record and the second record 514 is an order type record. Each of the first and second records 512 and 514 includes or is associated with a unique ID and a set of fields with associated metadata and content. For example as is shown in FIG. 5 by way of a non-limiting example, the event type form instance record 512 includes a field for each one of: type, title, description, event date, participants and a field for the unique ID. Further by way of a non-limiting example, the order type form instance record 514 includes a field for each one of: type, title, code, order data, total price and a field for the unique ID.

According to some embodiments of the invention, at some point, a request may be received, for example through a GUI component that is associated with the host application interaction module 30, to publish one or more of the form instance records within the embedded storage layer 70 of the information container 62. As mentioned above, an instruction to publish may relate to a specific one or ones of the form instance records or the instruction may relate to the records as a collective (and thus to each one of the records). Upon receiving a request to publish a form instance record, the host application interaction module 30 may utilize the form data publisher 50 in order to carry out the publishing of the record(s). According to some embodiments of the invention, the host application interaction module 30 may be configured to cause the publishing of data which corresponds to a newly created form instance (or some portion thereof) and/or the publishing of data which corresponds to an update applied in respect of an existing form instance.

The request may specify to the publisher 50 which data is being requested (which record and/or which field is being requested) and the publisher 50 may in response extract the relevant data from the embedded storage layer 70 of the information container. The publisher 50 may be configured to extract from the embedded storage layer 70 any data which may be necessary in order to respond to the instruction to publish the record(s). According to some embodiments of the invention, the publisher 50 may extract the entire record that is to be published, and/or in accordance with further embodiments, the publisher 50 may be configured to extract only a specific part of a record which is of interest. For example, when a specific field of one record within the embedded storage layer 70 has been updated, the publisher may be configured to extract with respect to the updated record data that is associated with the field that has been updated and the unique ID of the record.

It would be appreciated that according to some embodiments of the invention, a record within the embedded storage layer 70 may be saved as a string of plain text, The string of plain text may represent tags or elements, metadata or attributes and content or values which the host application interaction module 30 may identify and interpret, for example, according to the XML standard and local or application specific XML definitions. Thus, for example, the host application interaction module 30 may locate within the embedded storage layer 70 a record with respect to a specific form instance by reading a certain string of plain text which represents the unique ID associated with the sought after record. In accordance with another example, the host application interaction module 30 may be configured to provide the publisher 50 with a specific portion of a record by reading the string of plain text associated with a certain record and identifying a portion within the string (for example, marked by a certain tag element) which corresponds to the sought after portion of the record.

According to some embodiments of the invention, the form data publisher 50 either independently or in cooperation with a controller 51 may be configured to forward the data corresponding to the form instance(s) to a remote form storage component 52. According to some embodiments of the invention, the publisher 50 may be associated with a plurality of remote form storage components 52. According to further embodiments of the invention, each one or each group of remote form storage components 52 may be associated with a specific type of forms. For example, in FIG. 5, there is shown a first and a second database 530 and 535 on which data corresponding to a form instance may be stored. The first database 530 is associated with order type form instances, and the second database 535 is associated with events type form instances. The allocation of storage resources for different types of forms is not constrained according to the physical structure of the storage media. Rather, according to some embodiments, data relating to certain types of forms may be distributed across different storage media, which may possibly be regarded as a common logical entity. Similarly, different types of forms may be kept on a single storage medium or on a single group of storage media.

The publisher 50, either independently or in cooperation with a controller 51, may be configured to direct each data segment (whether it is data which corresponds to an entire form instance record or only to a portion of a record) to the appropriate remote storage component, for example according to the type of the form instance. Thus, a remote form storage component 52 that is associated with a certain type of forms may receive data which belongs to that type of form. It should be appreciated, that according to some embodiments of the invention, each remote form storage component 52 may be a distinct storage device, or that in accordance with further embodiments of the invention, several remote form storage components 52 may be defined on a single storage device, for example, by designating certain areas or addresses on the storage device for each remote form storage component 52 that is implemented on that storage device.

According to some embodiments of the invention, the form data publisher 50 may receive from the host application interaction module 30 a string of plain text and may forward the plain text to the remote form storage component 52. The remote form storage component 52 may process the plain text string and store the data in a table. For example, the remote form storage component 52 may be configured to identify within the plain text string sequences which represent a certain tag element and/or metadata and/or a value or content and may update a table kept by the remote form storage component 52 according to the identified tags, metadata and values or content. However, in accordance with further embodiments of the invention, the processing of the data may be carried out by the form data publisher 50 or by the controller 51, which may write the data directly into the appropriate cell of a table kept by the remote form storage component 52.

According to some embodiments of the invention, once the data is available on the remote form storage component 52 it may be accessed and/or manipulated by any node that is in communication with the remote form storage component 52. It would be appreciated that in accordance with some embodiments of the invention, the interaction with the data on the remote storage component 52 may not influence, in and of itself, the state of the corresponding data within the embedded storage layer 70 of the information container 62.

According to some embodiments of the invention, a change monitor 540 may be utilized to monitor the data on a remote form storage component 52 in a manner to detect changes to a form instance record on the remote storage component 52. The change monitor 540 may be further adapted to specify the manner by which the record was altered.

According to some embodiments of the invention, upon detecting a change in respect of a form instance record on a remote storage component 52, the change monitor 540 may be adapted to notify a host application interaction module 30 that is associated with an information container 62 which holds the form instance which corresponds to the changed record. It would be appreciated, that according to some embodiments of the invention, if there are several (e.g., more than one) information containers 62 which hold the form instance which was changed on the remote storage component 52, the host application interaction module 30 associated with each one of these information containers 62 may receive a notification about the change, so as to enable updating each one (or some) of the records associated with the changed form instance.

It would be appreciated, that according to some embodiments of the invention, each record within a remote storage component 52 that is associated with a form instance may include some data which may enable to determine with which host interaction module(s) 30 and/or with which information container 62 that form instance is associated. According to some embodiments of the invention, the unique ID associated with each form instance may be sufficient to determine with which host application interaction module 30 and/or with which information container 62 that form instance is associated.

For example, according to some embodiments of the invention, a host application interaction module reference table (not shown) may be provided wherein each form instance record on a remote storage component 52 may be registered with reference to the host application interaction module(s) 30 and/or to the information container(s) 62 with which it is associated. A reference between a certain form instance record on a remote storage component 52 and a host application interaction module(s) 30 and/or an information container(s) 62 may be determined by reading the appropriate data within the host application interaction module reference table. However, according to further embodiments of the invention, the reference between the host application interaction module(s) 30 and/or the information container(s) 62 and a form instance record on a remote storage component 52 may be included as part of the record of the form instance on the remote storage component 52. Thus, the reference between a certain form instance and a host application interaction module(s) may be determined by reading the appropriate data within the record that is associated with the form instance on the remote storage component 52.

According to some embodiments of the invention, a link may be established between two or more form instances. The linked form instances may be located in different information containers and different remote storage components. The link between the form instances may be used and managed according to rules and predefined criteria. Various linking schemes may be implemented including one-to-one, one-to-many and many-to-many. For example, according to some embodiments of the invention, a first and a second form instance may be linked to one another and a rule may be created according to which whenever the first form instance is updated, an alert is enabled within the second form instance. According to further embodiments of the invention, a record within a remote storage component 52 that is associated with the second form instance may be created according to the changes with respect of the first form instance and in accordance with the alert which has been enabled. A controller or management module (not shown) which is associated with the remote storage component 52 may detect the new record and in response to the alert being enabled may carry out a predefined action, for example, may send an email with details regarding the change as reflected by the record that is associated with the second form instance.

According to further embodiments of the invention, the change notification from the change monitor 540 may include data about the manner by which the respective record has been altered. According to still further embodiments of the invention, the notification from the change monitor 540 may also include additional data which may describe some circumstances of the change or alteration of the respective record. For example, the notification may specify the time and date of the change, the identity of user or computer from which the changes were received, some indication about the importance or validity of the changes, etc.

According to some embodiments of the invention, upon receiving a change notification from the change monitor 540, the host application interaction module 30 may be adapted to update the respective record stored within the embedded storage layer of an information container 62 which includes a record of the form instance which was changed on the remote storage component 52. The update may be carried out according to the changes reported by the change monitor 540, and/or the host application interaction module 30 may be adapted to update the respective indication within the presentation layer that is associated with the form instance which was changed on the remote storage component 52. The update may be carried out according to the changes reported by the change monitor 540.

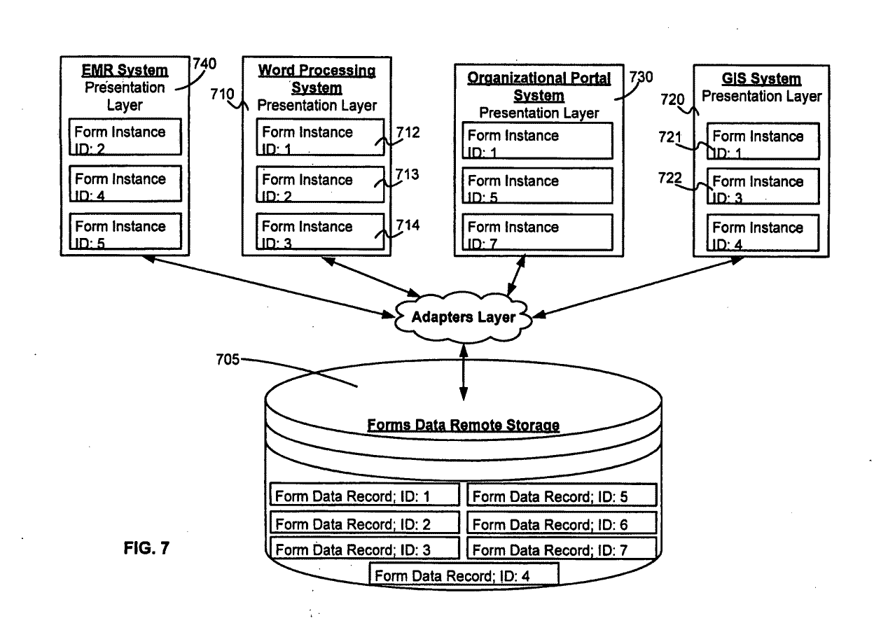

It would be appreciated that according to further embodiments of the invention, a change on a remote storage component may give rise to a corresponding change with respect to another record on a different storage component when the two records are associated and the change is relevant to both records. According to further embodiments of the invention, a change with respect to one record of a form instance within a first information container may give rise to a corresponding change with respect to a second form instance record within a second information container, either directly or through the changing of a corresponding form instance record on a remote storage component 52. The connection between different information containers and between different information manipulation environments shall be discussed below with reference to FIG. 7.

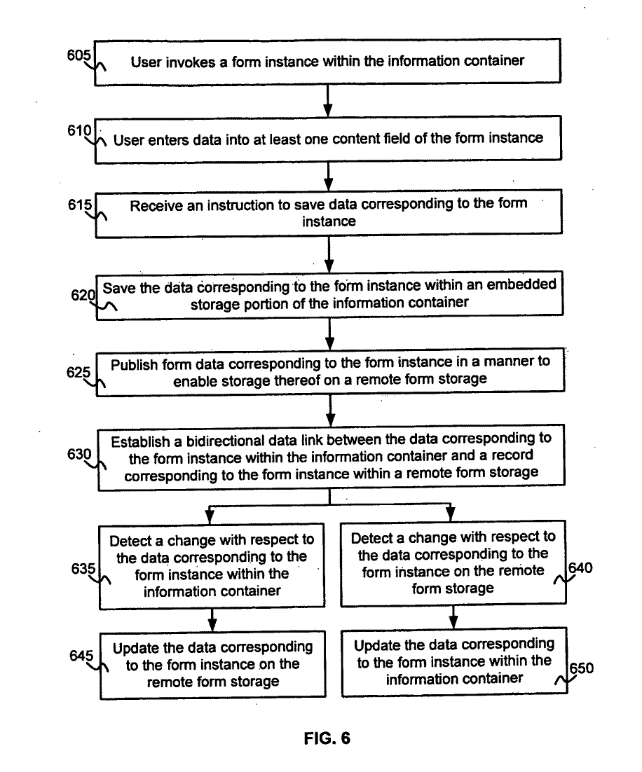

Reference is now made to FIG. 6, which is a flowchart illustration scenario whereby an information container is introduced with a form instance, according to some embodiments of the invention. According to some embodiments of the invention, a form instance may be introduced into an information container. For example, according to some embodiments of the invention, a user may invoke a form instance within the information container substantially as described above (block 605). Next, the user may enter data into at least one field of the form instance (block 610), and an instruction to save the data corresponding to the form instance may be received (block 615).

According to some embodiments of the invention, in response to the instruction to save the form instance, data corresponding to the form instance may be stored within an embedded storage layer of the information container (block 620). After the data is saved within embedded storage layer of the information container, the data may also be published in a manner to enable storage thereof on a remote storage component (block 625). According to some embodiments of the invention, the publication of the data may be automatically triggered by the storage of the new data within the embedded storage layer and may substantially overlap with the storage of the data within the embedded storage layer. According to further embodiments of the invention, the publication may not occur automatically upon the storage of the data within the embedded storage layer and may depend upon some event which is defined as a trigger for publication of the data and/or may depend upon an instruction from a user or a program to publish the data. According to still further embodiments of the invention, various combinations of automatic (e.g., event dependent) and user initiated publication may be defined. For example, the initial publication may be triggered in response to the storage of the data within the embedded storage layer, whereas subsequent publication may require the user's approval or instruction.

Once the data is published on a remote storage component, a bidirectional link may be established between the data within the embedded storage layer and the corresponding data on the remote storage components (block 630). For example, according to an embodiment of the invention, the host application interaction module may be configured to detect changes or updates with respect to a certain record within the embedded storage layer (block 635) and may notify a remote form data storage component which holds data that is associated with the changed or updated record about the changes in a manner to enable updating of the corresponding data on remote form data storage component (block 645). In accordance with another example, the remote form data storage component may be configured to detect changes or updates with respect to a certain record within the embedded storage layer (block 640) and may notify a host application interaction module that is responsible for managing data that is associated with the changed or updated record on the remote storage component in a manner to enable updating of the corresponding data within the embedded storage layer (block 645). The interaction between the host application interaction module and the remote form data storage component(s) and vice-versa may be carried out through a controller which is configured to direct incoming data to its appropriate destination. The controller may also be used to manage some operations with respect to the remote form data storage component, including, for example, identifying changes or updates to certain data stored on a remote form data storage component.

It should be appreciated that publishing of data corresponding to a form instance is only one example of an application which may be combined with the introduction of form instances into an information container, and that other applications are contemplated. Non-limiting examples of additional applications are provided below.

According to one non-limiting example, a board meeting may be held, and one of the attendees is requested to summarize the meeting. The person who is in charge of summarizing the meeting may open a Microsoft® Office Word 2003 document, and may use the host application interaction module to insert a decision type form instance into the document. After documenting all meeting decisions by inputting values or content into the relevant fields of the form instances, the user may utilize the host application interaction module to publish onto an enterprise decision management system all the decision type forms inserted into the Microsoft® Office Word 2003 document. Thus, data associated with the decisions is saved in a public location.

In the next few days/weeks/months, etc. the decisions arrived at during the board meeting may be followed up, and may be updated accordingly on the enterprise decision management system. During the next board meeting, the meeting summary document (a Microsoft® Office Word 2003 document) may be opened again, and the decisions may be reviewed. Meeting attendees can ask for updates on any changes in the decisions' status or result by “refreshing” form instances. The updated data may be brought or retrieved from the enterprise decision management system into the document and the display may be updated in accordance with the updated data. This process may continue with additional updates to the form instances based on the review of the decisions status. The updates can also be published, and so on.

In another non-limiting example, a user may read a Microsoft® Office Word 2003 document and may wish to receive a clarification regarding some paragraph in the document. The user may add a form instance to the document. For convenience, this type of form shall be referred to herein as a “business query” type form instance. According to an embodiment of the invention, the “business query” type form instance may include a field which the user can use for describing his question regarding the paragraph of interest, and another field in which the user can define the technical domain of his query (for instance: biomechanics->brain cells). The technical domain field may provide the user with a predefined list of values for the user to choose from.

Once the user is finished entering the data into the form instance, the data may be stored within an embedded storage layer of the document, and the query (which is represented by the form instance data) may be published. According to one example, the query may be documented on a query documentation database according to its business definition, and also the query may be sent by an e-mail sweeper to other users. For example, an email with data corresponding to the query may be sent to users that are associated with the technical domain specified by the user.

Users who wish to clarify the issue in question may reply by email. The email may be received by the query documentation database and stored thereon, for example. The response may also be detected by some query or response management entity. The query or response management entity may cause some indication of the actual response to be added to the original document, for example, through an interaction with the host application interaction module that is associated with the original document. The interaction may be carried out through reference to some unique ID that has been associated with the query. The unique ID may be unique throughout the system and may be recognized by the various elements of the system.

Further by way of illustration, when the original document is opened, an indication in the document may be given to the user that the query has been replied to. The user can choose to “refresh” the form instance, and thereby cause the record associated with the form within the embedded storage layer of the document to be updated with one or more (in case of many) of the replies.

Still further by way of illustration, at some point the organization can analyze and run statistics on queries according to the different business definitions and topics. This analysis can be carried out by processing the data on the query documentation database, for example. In accordance with one example, the enterprise may thus better understand the main topics that are discussed by employees, and may effectively plan steps to create a better knowledge base with respect to a certain area or field of expertise.

Reference is now made to FIG. 7, which is a block diagram of various applications of a system and a method of enabling introduction of a form instance into an information container and of possible interactions between copies of a certain form instance across different information containers and different information manipulation environments. According to a non limiting example, a user in a defense organization may write an intelligence findings report into a Microsoft® Office Word 2003 document 710. The user may use the host application interaction module associated with the Microsoft® Office Word 2003 software environment to insert an intelligence finding type form instance(s) 712-714 into the document. In FIG. 7, the form instances 712-714 inserted into the Microsoft® Office Word 2003 document 710 are referenced with ID numbers 1, 2, 3.

After documenting all intelligence findings by inputting geographical data (e.g., coordinates, map reference, etc.) and other values or content into the relevant fields of the form instance(s) the user may utilize the host application interaction module associated with the Microsoft® Office Word 2003 software environment to publish onto an enterprise intelligence findings system the intelligence finding type form instance(s) inserted into the Microsoft® Office Word 2003 document. Thus, data associated with the intelligence findings may be saved on a public storage resource 705 and may be made available for being accessed and used by other systems or users of/within the organization.

For example, according to some embodiments of the invention a connection may be established between the intelligence findings system and a Geographic Information System (GIS) through the public storage resource. A user of the geographic information system may open a map 720 (the map functions as an information container) and insert into it existing intelligence finding forms instances that were originally created in the Microsoft© Office Word 2003 document 710, For example, as is shown in FIG. 7, the form instances 721 and 722 associated with ID numbers 1 and 3 which received data inputs through the Microsoft® Office Word 2003 document may be imported into the geographic information system map 720.

According to one non-limiting example, by using their saved geographical data, the intelligence finding forms instances 721 and 722 (associated with IDs 1 and 3) may be presented on specific points on the map 720 and provide an intelligence findings layer to the geographic information system. The geographic information system user may open an intelligence finding form instance (for example the one associated with ID 1), edit its data and utilize the host application interaction module to publish the updated intelligence finding form instance onto the enterprise intelligence findings system.

As is also shown in FIG. 7, by creating a form instance within a certain information container and publishing the form instance onto a public storage resource 705 (such as an enterprise files server, for example), various form instances may be distributed across different information containers and different information manipulation environments. For example, as is shown in FIG. 7, various form instances may be distributed across the Microsoft® Office Word 2003 document 710, the geographic information system map 720, an organizational portal page 730 and an Electronic Medical Record system record (EMR) 740.

It would be appreciated, that according to some embodiments of the invention, the distribution of form instances may be governed by predefined rules and may be automatic, manual and/or semi-automatic. Furthermore, it would be appreciated, that according to some embodiments of the invention, different information manipulation environments and/or different information containers may be configured to process incoming form instances, for example, according to predefined rules and may modify one or more fields, metadata and content of a form instance before inserting the form instance. According to another embodiment of the invention, different information manipulation environments and/or different information containers may be configured to display a form instance in a specific way, for example, according to predefined rules.

It would be appreciated that while some of the examples provided herein relate specifically to Microsoft® Office Word 2003 or to other Microsoft® Office 2003 applications, embodiments of the present invention are not limited to being implemented with respect to the particular information manipulation environments to which the examples provided herein relate.

With specific reference to Microsoft® Office Word 2007, it should be appreciated that while Microsoft® Office Word 2007 enables the inserting of fields into a Microsoft® Office Word 2007 document, the fields which are allowed by Microsoft® Office Word 2007 may typically be restricted according to a predefined allowed format. Furthermore, it would be appreciated that the fields which are allowed by Microsoft® Office Word 2007 document are typically presented only as free text fields and do not provide the user with a convenient way of entering or choosing data (for example a drop down list or a tree control). Yet further, the value that is entered by a user for a field will typically be the only value saved for that field and the user will typically not be allowed to enter or view any other data regarding that field. Furthermore, while a predefined field may be inserted in several places inside a Microsoft® Office Word 2007 document, all of its copies are typically based on the same data source, so that changing the content in one copy will typically lead to updates with respect of the content of each of the other copies of that field in the document. Still further, typically fields in a Microsoft® Office Word 2007 document are used locally inside the document and typically have no inherent connection to an external storage component as autonomous objects.

While certain features of the invention have been illustrated and described herein, many modifications, substitutions, changes, and equivalents will occur to those skilled in the art. It is therefore to be understood that the appended claims are intended to cover all such modifications and changes as fall within the true scope of the invention.

1. A system for enabling introduction of a form instance into an information container, the system comprising:
a form provisioning module configured for providing a form template from amongst a plurality of form templates, each one of said form templates including one or more data fields and at least one of said data fields including metadata and an editable value;
a host application interaction module, said host application interaction module is configured to interact with an information manipulation environment that is associated with said information container, to thereby invoke within said information container a form instance that is based upon one of said plurality of form templates, and to thereby enable editing of at least one value of one field of said form instance; and
said host application interaction module is adapted to store within an embedded storage layer of said information container data corresponding to one or more fields of said form instance, in a manner to enable access to said fields autonomously through said information container.

2. The system according to claim 1, wherein said host application interaction module is adapted to interact with said information manipulation environment, to thereby add to a presentation layer of said information container an indication with respect to said form instance or with respect to any of its fields.

3. The system according to claim 2, wherein said host application interaction module is adapted to generate said indication with respect to said form instance so that said indication provides a visual representation of a metadata and/or a content of a field of said form instance.

4. The system according to claim 3, wherein said host application interaction module is adapted to link said metadata and/or said content that is associated with said form instance within said embedded storage layer with said indication with respect to said form instance, such that in case said metadata and/or said content is updated, said update is reflected by said indication.

5. The system according to claim 1, further comprising:
a form template repository for storing form templates, and
wherein said form provisioning module is adapted to retrieve a form template from said form template repository in response and based upon a request from a user including details about a requested form template and/or based upon a predefined criterion.

6. The system according to claim 5, wherein said form template repository is configured to store ready-made form templates and user defined form templates.

7. The system according to claim 5, further comprising a form template user interface, said form template user interface is configured to enable a user to create a new form template or to modify an existing form template, and said form template user interface further enables a user to store said new or modified form template on said form template repository.

8. The system according to claim 1, further comprising a form data publisher, said form data publisher is adapted to publish data corresponding to one or more fields of said form instance for provisioning storage thereof on a remote storage component.

9. The system according to claim 8, wherein the data associated with said form instance within each of said embedded storage areas and said remote storage components exists autonomously of one another, such that the data corresponding to one or more fields of said form instance is autonomous from the information container.

10. The system according to claim 8, wherein said host application interaction module is adapted to detect a change in respect of said data corresponding to one or more fields of said form instance within said embedded storage layer, and wherein said host application interaction module is responsive to said change being detected for causing said data corresponding to one or more fields of said form instance on said remote storage component to be updated according to said change.

11. The system according to claim 8, further comprising:
a change monitor, said change monitor being configured to detect a change with respect to a form instance record on said remote storage component; and
said change monitor is responsive to said change being detected for providing an indication about said change to a host application interaction module which is associated with an information container which includes a record which corresponds to said form instance in respect of which a change was detected on said remote storage component.

12. The system according to claim 11, wherein said host application interaction module is responsive to said indication being received for updating said form instance record according to said change indication.

13. The system according to claim 8, further comprising:
a plurality of remote storage components, one or more of said remote storage components is being configured to store data in respect of form instance of a specific type; and
a controller, said controller is responsive to said form data publisher publishing data corresponding to a form instance, for determining a type of said form instance; and
said controller is responsive to said type of said form instance, for directing said data corresponding to said form instance to a specific one of said plurality of remote storage components for being stored thereon.

14. The system according to claim 12, wherein said host application interaction module further adapted to cause one or more of the following:
invocation of a comparison between a content of a selected form instance that is stored within an embedded storage layer of an information container and a content of a record on a remote storage component which corresponds to said selected form instance;
opening of a form instance that is stored within an embedded storage layer of an information container for enabling editing of said form instance;
deletion of a form instance from an embedded storage layer of an information container;
retrieval of data corresponding to a form instance from a remote storage component and storage of said retrieved data within an embedded storage layer of an information container; and
disconnection of a link between a selected form instance stored within an embedded storage layer of an information container and a counterpart record corresponding to said selected form instance that is stored on a remote storage component.

15. A method of enabling introduction of a form instance into an information container, the method comprising:
selecting a form template from amongst a plurality of form templates, each one of said form templates including one or more data fields and at least one of said data fields including metadata and an editable value;
invoking a form instance that is based upon said selected form template within an information container that is associated with an information manipulation environment;
editing at least one value of one field of said form instance; and
storing within an embedded storage layer of said information container data corresponding to one or more fields of said form instance, in a manner to enable access to said fields autonomously through said information container.

16. The method according to claim 15, further comprising adding to a presentation layer of said information container an indication with respect to said form instance or with respect to any of its fields.

17. The method according to claim 16, wherein said adding comprises generating said indication with respect to said form instance so that said indication provides a visual representation of a metadata and/or a content of a field of said form instance.

18. The method according to claim 17, further comprising linking said metadata and/or said content that is associated with said form instance within said embedded storage layer with said indication with respect to said form instance, such that in case said metadata and/or said content is updated, said update is reflected by said indication.

19. The method according to claim 15, wherein said selecting further comprises retrieving said selected form template from a form template repository in response and based upon a request from a user including details about a requested form template and/or based upon a predefined criterion.

20. The method according to claim 15, further comprising publishing data corresponding to one or more fields of said form instance in a manner to enable storage of said one or more fields of said form instance on a remote storage component.

21. The method according to claim 20, wherein said data associated with said form instance within each of said embedded storage areas and said remote storage components exists autonomously of one another, such that the data corresponding to one or more fields of said form instance is accessible autonomously from the information container, without being required to retrieve data from any remote data source.

22. The method according to claim 20, further comprising:
detecting a change in respect of said data corresponding to one or more fields of said form instance within said embedded storage layer; and
causing said data corresponding to one or more fields of said form instance on said remote storage component to be updated according to said change.

23. The method according to claim 20, further comprising:
detecting a change with respect to a form instance record on said remote storage component; and
providing an indication about said change to a host application interaction module which is associated with an information container which includes a record which corresponds to said changed form instance in respect of which a change was detected on said remote storage component.

24. The method according to claim 23, further comprising updating said form instance record according to said change indication.

25. The method according to claim 20, further comprising:
providing a plurality of remote storage components, one or more of said remote storage components is configured to store data in respect of form instance of a specific type;
determining type of a form instance in respect of which data is being published; and
directing said data corresponding to said form instance to a specific one of said plurality of remote storage components for being stored thereon according to said type of said form instance.

26. A program storage device readable by machine, tangibly embodying a program of instructions executable by the machine to perform a method of enabling introduction of a form instance into an information container, the method comprising:
selecting a form template from amongst a plurality of form templates, each one of said form templates including one or more data fields and at least one of said data fields including metadata and an editable value;
invoking a form instance that is based upon said selected form template within an information container that is associated with an information manipulation environment;
editing at least one value of one field of said form instance; and
storing within an embedded storage layer of said information container data corresponding to one or more fields of said form instance, in a manner to enable access to said fields autonomously through said information container.
